(19) United States
(12) Patent Application Publication
(10) Pub. No.: US 2012/0301718 A1
(43) Pub. Date: Nov. 29, 2012

(54) METAL-RESIN COMPOSITE

(76) Inventors: Katsunori Nishiura, Chiba-shi (JP); Masahiro Toriida, Sodegaura-shi (JP); Wataru Yamashita, Ichihara-shi (JP)

(21) Appl. No.: 13/575,745

(22) PCT Filed: Jan. 27, 2011
(86) PCT No.: PCT/JP2011/000450

§ 371 Date: Jul. 27, 2012

(30) Foreign Application Priority Data
Jan. 28, 2010 (JP) 2010-016989

(51) Int. Cl. B32B 1/00; B32B 15/088; H01B 3/30; B32B 15/08; B32B 5/16; B32B 15/085; B32B 15/095

(52) U.S. Cl. 428/380; 428/461; 428/458; 428/462; 428/425.8; 174/110 SR

(57) ABSTRACT

Provided is a metal-resin composite provided with a layer consisting of a heat-resistant resin composition having a low permittivity or a low dielectric loss tangent. The composite can exhibit a low thermal expansion coefficient and a reduced transmission loss of an electric signal. The composite comprises a metal and a resin layer (I). The resin layer (I) is made from a resin composition prepared by blending (A) a heat-resistant resin that exhibits a relative permittivity of 2.3 or more at a frequency of 1 MHz with (B) polyolefin particles having a mean particle diameter of 100 [mu]m or less. The resin composition has both a continuous phase of the heat-resistant resin (A) and a dispersed phase of the polyolefin particles (B), with the relative permittivity of the resin composition being lower than that of the heat-resistant resin (A).

### TECHNICAL FIELD

The present invention relates to a metal-resin composite.

### BACKGROUND ART

Conventionally, plastic materials have been widely used for electronic devices and electronic parts such as substrates for circuits as an insulating member that needs to have reliability, because the plastic materials have such properties as high insulation, dimensional stability, and moldability. Recently, along with a higher processing rate and a higher transmission rate in the electronic devices, use of electric signals with a higher frequency has increased.

Usually, the transmission loss of an electric signal is proportional to the product of a frequency, a relative permittivity, and a dielectric loss tangent. Accordingly, the transmission loss is larger as the frequency of the electric signal to be used is higher. In order to reduce the transmission loss of the electric signal to deal with the use of the electric signal with a higher frequency, a plastic material having a low permittivity and a low dielectric loss tangent has been demanded.

Usually, the permittivity depends on the kind of the material, and selection of a plastic material having a low permittivity has been proposed. Examples of the plastic material having a low permittivity include olefin resins such as polyethylene (PE) and fluorinated resins such as polytetrafluoroethylene (PTFE). Unfortunately, the fluorinated resins have poor molding processability, although they have sufficient heat resistance. Moreover, the olefin resins have a low a heat resistant temperature of 100° C. or lower.

Contrary to this, it is known that polyimides have a high heat resistance among the plastic materials and most of the polyimides have a high permittivity. For this reason, a variety of methods for reducing the permittivity of the polyimide have been proposed. For example, a method has been proposed in which a fluorine group is introduced into a polyimide skeleton to reduce the permittivity of the polyimide. Excessive introduction of a fluorine group into the polyimide skeleton, however, leads to such deficits that adhesion to a Cu wiring material is reduced when the polyimide is used for a printed circuit board, or solvent resistance is reduced.

Moreover, another method has been proposed in which a bulky skeleton is introduced into a polyimide skeleton to reduce the density of a resin, thereby to reduce the permittivity thereof. Introduction of the bulky skeleton impairs main chain packing of the polyimide, leading to deficits such as reduction in mechanical strength and increase in a thermal expansion coefficient. Particularly, in order to reduce dimensional change, the plastic material used for the circuit substrate and the like should have low thermal expansivity. Additionally, the difference between the thermal expansion coefficient of the plastic material and that of the Cu wiring material is required to be as small as possible.

Further, a method has been proposed in which a plastic material such as polyimides is porosified to reduce the permittivity (for example, see PTLs 1 to 4). Namely, a large number of pores having a low permittivity are contained in the plastic material to reduce the permittivity of the plastic material as a whole. Examples of a known method for porosifying a plastic include a method in which a gas such as nitrogen and carbon dioxide is dissolved in a polymer under high pressure; then, the pressure is rapidly released, and the polymer is heated to the temperature close to the glass transition temperature or softening point of the polymer to be porosified.

Moreover, as a method for producing a porous body, a method has been proposed in which a heat-resistant polymer is mixed with a thermally decomposable polymer to form a preform; then, the thermally decomposable polymer is heated and baked to a temperature not less than the decomposing temperature of the decomposable polymer to decompose and remove the decomposable polymer, thereby to obtain a porous body (for example, see PTL 5).

### CITATION LIST

### Patent Literature

### PTL 1

Japanese Patent Application Laid-Open No. 2003-201362

### PTL 2

Japanese Patent Application Laid-Open No. 2000-154273

### PTL 3

Japanese Patent No. 3115215

### PTL 4

Japanese Patent Application Laid-Open No. 2002-3636

### PTL 5

Japanese Patent Application Laid-Open No. 63-278943

### SUMMARY OF INVENTION

### Technical Problem

In porosification of the plastic material such as polyimides, however, there are problems such as increase in mechanical strength and increase in the thermal expansion coefficient. Additionally, it is difficult to produce the material for a circuit substrate and a wiring material comprising such a porosified plastic material by an ordinary production apparatus, and investment in facilities is needed. For this reason, the porosified plastic material for a circuit substrate and a wire cannot be simply produced at low cost.

As described above, in the related art, it is difficult to produce a heat-resistant plastic material having a low permittivity and a low thermal expansion coefficient in a simple manner. The present invention has been made in consideration of such circumstances, and an object of the present invention is to provide a heat-resistant resin composition having a low permittivity or dielectric loss tangent, and having a low thermal expansion coefficient; and to provide a metal-resin composite comprising the heat-resistant resin composition.

### Solution to Problem

As a result of extensive research, the present inventors found out that when a specific polyolefin particle is added to and dispersed in a heat-resistant resin such as polyimides, not only the permittivity of the heat-resistant resin can be reduced, but also increase in the thermal expansion coefficient of the resin caused by addition of the polyolefin particle can be minimized. The present invention has been made based on such knowledge.

The present invention relates to a metal-resin composite below.

[1] A metal-resin composite including a metal and a resin layer (I) provided in direct contact with the metal or provided over the metal, with an intermediate layer provided between the resin layer (I) and the metal, wherein the resin layer (I) is obtained from a resin composition prepared by blending a heat-resistant resin (A) with polyolefin particles (B) and the heat-resistant resin (A) having a relative permittivity at a frequency of 1 MHz of 2.3 or more, the polyolefin particles (B) having a mean particle size of 100 μm or less; the resin composition has a continuous phase of the heat-resistant resin (A) and a dispersed phase obtained from the polyolefin particles (B); and a relative permittivity of the resin composition is lower than that of the heat-resistant resin (A).

[2] The metal-resin composite according to [1], wherein the heat-resistant resin (A) is at least one selected from the group consisting of polyimides, polyamideimides, liquid crystal polymers, and polyphenylene ethers.

[3] The metal-resin composite according to [1] or [2], wherein the heat-resistant resin (A) is a polyimide.

[4] The metal-resin composite according to any one of [1] to [3], wherein the resin composition has a relative permittivity at a frequency of 1 MHz of 3.3 or less.

[5] The metal-resin composite according to any one of [1] to [4], wherein the polyolefin particles (B) are a polymer comprising a structural unit derived from at least one monomer selected from the group consisting of ethylene, propylene, 1-butene, and 4-methyl-1-pentene.

[6] The metal-resin composite according to any one of [1] to [5], wherein the polyolefin particles (B) have a polar group.

[7] The metal-resin composite according to [6], wherein the polar group is at least one functional group selected from the group consisting of a hydroxyl group, a carboxyl group, an amino group, an amide group, an imide group, an ether group, a urethane group, a urea group, a phosphate group, a sulfonate group, and a carboxylic anhydride group.

[8] The metal-resin composite according to any one of [1] to [7], wherein the polyolefin particles (B) are subjected to a corona treatment, a plasma treatment, irradiation with an electron beam, or an UV ozone treatment.

[9] The metal-resin composite according to any one of [1] to [8], wherein the resin composition contains 5 weight parts or more and 200 weight parts or less of the polyolefin particles (B) based on 100 weight parts of the heat-resistant resin (A).

[10] The metal-resin composite according to any one of [1] to [9], wherein the resin composition further contains a flame retardant.

[11] The metal-resin composite according to any one of [1] to [10], wherein a dielectric loss tangent at a frequency of 1 MHz of the heat-resistant resin (A) is 0.001 or more, and a dielectric loss tangent of the resin composition is lower than the dielectric loss tangent of the heat-resistant resin (A).

[12] The metal-resin composite according to any one of [1] to [11], wherein the metal is a metallic layer, and the metal-resin composite is a metal laminate comprising the metallic layer and the resin layer (I) laminated directly or laminated with an an intermediate layer between the metallic layer and the resin layer (I).

[13] The metal-resin composite according to [12], wherein the laminate is a substrate for a circuit.

[14] The metal-resin composite according to [12] or [13], wherein the laminate is a substrate for a high frequency circuit.

[15] The metal-resin composite according to any one of [1] to [11], wherein the metal is a metallic wire, and the metal-resin composite is a coated metal body in which an outer peripheral surface of the metallic wire is coated with the resin layer (I) directly or is coated with the resin layer (I), with an intermediate layer between the metallic wire and the resin layer (I).

[16] The metal-resin composite according to [15], wherein the coated body is an electric wire.

### Advantageous Effects of Invention

According to the present invention, a heat-resistant resin composition having a low permittivity or dielectric loss tangent and a low thermal expansion coefficient can be provided. Thereby, metal-resin composite having a layer (the resin layer (I)) comprising the resin composition can have a reduced transmission loss of the electric signal.

### BRIEF DESCRIPTION OF DRAWING

FIG. 1 is a TEM image of a cross section of a film according to Production Example.

### DESCRIPTION OF EMBODIMENTS

### 1. Metal-Resin Composite

A metal-resin composite according to the present invention comprises a metal, and a resin layer (I) provided in direct contact with the surface of the metal or provided over the surface of the metal, with an intermediate layer between the resin layer (I) and the metal. The intermediate layer can be an adhesive layer, for example. A plurality of metals and a plurality of the resin layers (I) may be provided. The metal-resin composite according to the present invention may further comprise a layer other than the metal, the resin layer (I), and the intermediate layer (for example, a resin layer other than the resin layer (I)).

About Metal

The metal can function as a conductor. The metal is not particularly limited, and examples thereof include metals such as copper, copper alloys, aluminum, nickel, gold, silver, and stainless steel. Among these, preferred is copper or copper alloys from the viewpoint of obtaining high conductivity. The metal may be a metallic layer or a metallic wire. The metallic layer may be a metallic foil, a metal plate, or the like.

About Resin Layer (I)

The resin layer (I) can function as an insulating layer that insulates the metal from others. The resin layer (I) is formed with a resin composition comprising a continuous phase of a heat-resistant resin (A) and a dispersed phase obtained from polyolefin particles (B). The dispersed phase obtained from the polyolefin particles (B) in the resin composition can be an aggregation of the added polyolefin particles (B) or a fused material thereof, for example.

About Heat-Resistant Resin (A)

As the heat-resistant resin (A), preferred are resins having a glass transition temperature of 150° C. or more from the viewpoint of increasing the heat resistance of the resin composition and reducing the thermal expansion coefficient thereof.

Such a heat-resistant resin (A) usually has a permittivity and a dielectric loss tangent higher than those of polyolefins. Accordingly, the relative permittivity at a frequency of 1 MHz of the heat-resistant resin (A) is usually 2.3 or more. The dielectric loss tangent at a frequency of 1 MHz of the heat-resistant resin (A) is usually 0.001 or more.

Examples of such a heat-resistant resin (A) include polyimides, polyamideimides, polyphenylene ethers, polyphenylene sulfides, polyethers, polyether ketones, polyether ether ketones, polyethylene terephthalates, polycarbonates, liquid crystal polymers, epoxy resins, polyethersulfones, and phenol resins. The liquid crystal polymer is a polymer that demonstrates liquid crystallinity in a liquid or molten state. From the viewpoint of high mechanical strength and heat resistance, the liquid crystal polymer is preferably a thermotropic liquid crystal polymer that demonstrates liquid crystallinity in a molten state.

Among these, more preferred are polyimides from the viewpoint of particularly high heat resistance and dimensional stability. The polyimides are preferably polyimides having a structural unit represented by the formula (1) in which m is an integer of 1 or more. Thus, the polyimide including relatively many aromatic rings in the molecule and having a rigid molecular structure has a high heat resistance and a low thermal expansion coefficient.

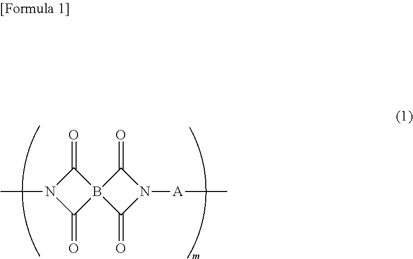

A in the formula (1) is selected from divalent groups represented by the following formula. X₁ to X₆ in the following formula each are a single bond, —O—, —S—, —CO—, —COO—, —C(CH₃)₂—, —C(CF₃)₂—, —SO₂—, or —NHCO—. X₁ to X₆ contained in a plurality of As may be the same or different from each other. R₁, R₂, R₃, and R₄ in the following formula may be the same or different from each other, and each independently represent a hydrogen atom or a hydrocarbon group having 1 to 12 carbon atoms.

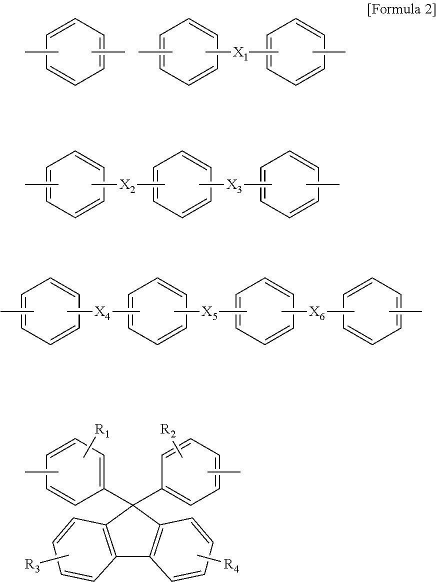

A in the formula (1) can be a divalent group derived from aromatic diamines. Examples of the aromatic diamines include: m-phenylenediamine, o-phenylenediamine, p-phenylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfone, 3,4′-di aminodiphenyl sulfone, 4,4′-diaminodiphenyl sulfone, 3,3′-diaminobenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenyl sulfoxide, 3,4′-diaminodiphenyl sulfoxide, 4,4′-diaminodiphenyl sulfoxide, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminophenyl sulfide)benzene, 1,3-bis(4-aminophenyl sulfide)benzene, 1,4-bis(4-aminophenyl sulfide)benzene, 1,3-bis(3-aminophenyl sulfone)benzene, 1,3-bis(4-aminophenyl sulfone)benzene, 1,4-bis(4-aminophenyl sulfone)benzene, 1,3-bis(3-aminobenzyl)benzene, 1,3-bis(4-aminobenzyl)benzene, 1,4-bis(4-aminobenzyl)benzene, 1,3-bis(3-amino-4-phenoxybenzoyl)benzene, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane, 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, 2,2-bis[4-(4-aminophenoxy)phenyl]-1,1,1,3,3,3-hexafluoropropane, 9,9-bis(4-aminophenyl)fluorene, 9,9-bis(2-methyl-4-aminophenyl)fluorene, 9,9-bis(3-methyl-4-aminophenyl)fluorene, 9,9-bis(2-ethyl-4-aminophenyl)fluorene, 9,9-bis(3-ethyl-4-aminophenyl)fluorene, 9,9-bis(4-aminophenyl)-1-methylfluorene, 9,9-bis(4-aminophenyl)-2-methylfluorene, 9,9-bis(4-aminophenyl)-3-methylfluorene, and 9,9-bis(4-aminophenyl)-4-methylfluorene. These may be used alone, or two or more thereof may be used in combination.

A in the formula (1) may contain divalent groups derived from other aliphatic diamines, other than the divalent groups derived from the aromatic diamine compounds.

Examples of the other aliphatic diamines include: 1,3-bis(3-aminopropyl)tetramethyldisiloxane, 1,3-bis(4-aminobutyl)tetramethyldisiloxane, α,ω-bis(3-aminopropyl)polydimethylsiloxane, α,ω-bis(3-aminobutyl)polydimethylsiloxane, bis(aminomethyl)ether, 1,2-bis(aminomethoxy)ethane, bis[(2-aminomethoxy)ethyl]ether, 1,2-bis[(2-aminomethoxy)ethoxy]ethane, bis(2-aminoethyl)ether, 1,2-bis(2-aminoethoxy)ethane, bis[2-(2-aminoethoxy)ethyl]ether, bis[2-(2-aminoethoxy)ethoxy]ethane, bis(3-aminopropyl) ether, ethylene glycol bis(3-aminopropyl)ether, diethylene glycol bis(3-aminopropyl)ether, triethylene glycol bis(3-aminopropyl)ether, ethylene diamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,2-diaminocyclohexane, 1,3-diaminocyclohexane, 1,4-diaminocyclohexane, 1,4-diaminomethylcyclohexane, 1,3-diaminomethylcyclohexane, 1,2-diaminomethylcyclohexane, 1,2-di(2-aminoethyl)cyclohexane, 1,3-di(2-aminoethyl)cyclohexane, 1,4-di(2-aminoethyl)cyclohexane, bis(4-aminocyclohexyl)methane, 2,6-bis(aminomethyl)bicyclo[2.2.1]heptane, and 2,5-bis(aminomethyl)bicyclo[2.2.1]heptane. These may be used alone, or two or more thereof may be used in combination.

B in the formula (1) is selected from tetravalent groups represented by the following formula. Y₁ to Y₆ in the following formula each are a single bond, —O—, —S—, —CO—, —COO—, —C(CH₃)₂—, —C(CF₃)₂—, —SO₂—, or —NHCO—. Y₁ to Y₆ contained in a plurality of Bs may be the same or different from each other.

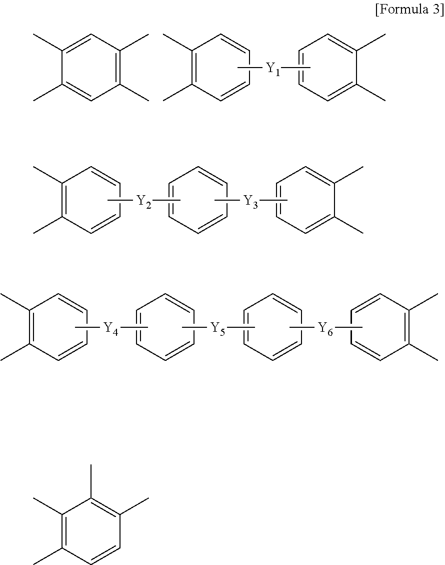

B in the formula (1) can be a tetravalent group derived from aromatic tetracarboxylic dianhydrides. Examples of the aromatic tetracarboxylic dianhydrides include: pyromellitic dianhydride, mellophanic dianhydride, 3,3′,4,4′-biphenyltetracarboxylic dianhydride, 2,3,3′,4′-biphenyltetracarboxylic dianhydride, 2,2′,3,3′-biplienyltetracarboxylic dianhydride, 3,3′,4,4′-benzophenonetetracarboxylic dianhydride, bis(3,4-dicarboxyphenyl)ether dianhydride, bis(2,3-dicarboxyphenyl)ether dianhydride, bis(3,4-dicarboxyphenyl)sulfide dianhydride, bis(3,4-dicarboxyphenyl)sulfone dianhydride, bis(3,4-dicarboxyphenyl)methane dianhydride, 2,2-bis(3,4-dicarboxyphenyl)propane dianhydride, 2,2-bis(3,4-di carboxyphenyl)-1,1,1,3,3,3-hexafluoropropane dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, and 2,2-bis[(3,4-dicarboxyphenoxy)phenyl]propane dianhydride. Preferable are pyromellitic dianhydride, and 3,3′,4,4′-biphenyltetracarboxylic dianhydride. These may be used alone, or two or more thereof may be used in combination.

B in the formula (1) may be a tetravalent group derived from other tetracarboxylic dianhydrides, other than the tetravalent groups derived from the aromatic tetracarboxylic dianhydrides.

Examples of the other tetracarboxylic dianhydrides include: ethylenetetracarboxylic dianhydride, butanetetracarboxylic dianhydride, cyclopentanetetracarboxylic dianhydride, 1,1-bis(2,3-dicarboxyphenyl)ethane dianhydride, 1,1-bis(3,4-dicarboxyphenyl)ethane dianhydride, 1,2-bis(2,3-dicarboxyphenyl)ethane dianhydride, 1,2-bis(3,4-dicarboxyphenyl)ethane dianhydride, 1,2,5,6-naphthalenetetracarboxylic dianhydride, 3,4,9,10-perylenetetracarboxylic dianhydride, 2,3,6,7-anthracenetetracarboxylic dianhydride, and 1,2,7,8-phenanthrenetetracarboxylic dianhydride. Tetracarboxylic dianhydrides may be used in which hydrogen atoms on the aromatic rings of these other tetracarboxylic dianhydrides are partially or entirely substituted with a fluoro group or a trifluoromethyl group. These may be used alone, or two or more thereof may be used in combination.

The weight-average molecular weight of the polyimide is preferably 5.0×10³ to 5.0×10⁵. At a weight-average molecular weight less than 5.0×10³, an aggregation force of a coating film is reduced, and physical properties of the coating film such as solvent resistance may be deteriorated; at a weight-average molecular weight more than 5.0×10⁵, coating is difficult. The weight-average molecular weight of the polyimide can be measured by gel permeation chromatography (GPC).

The polyimide having the structural unit represented by the formula (1) is obtained by heating a polyamic acid including a structural unit represented by the following formula (2) to be imidized. A, B, and m in the formula (2) are the same as A, B, and m in the formula (1), respectively.

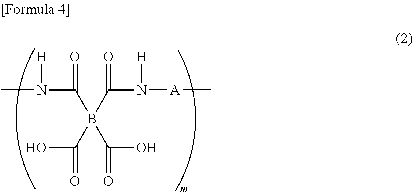

The polyamic acid is obtained by a polycondensation reaction of a diamine represented by the following formula (2A) with a tetracarboxylic dianhydride represented by the following formula (2B), for example.

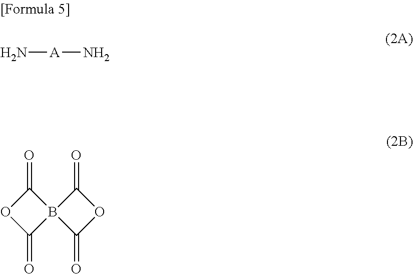

Preferably, the ratio of tetracarboxylic dianhydride to diamine to be prepared satisfies M1:M2=0.900 to 0.999:1.00 (M1: the number of moles of tetracarboxylic dianhydride, M2: the number of moles of diamine). M1:M2 is preferably 0.92 to 0.995:1.00, more preferably 0.95 to 0.995:1.00, and still more preferably 0.97 to 0.995:1.00. This is for obtaining a polyamic acid having an amine terminal.

About Polyolefin Particles (B)

The polyolefin particles (B) have a low permittivity and a low dielectric loss tangent. Accordingly, if the polyolefin particles (B) are added to the heat-resistant resin (A), the permittivity of the resin composition can be reduced. Such polyolefin particles (B) comprise a monopolymer or copolymer containing a monomer selected from hydrocarbons having 2 to 20 carbon atoms. Among the hydrocarbons having 2 to 20 carbon atoms, preferred are hydrocarbons having 2 to 10 carbon atoms.

Examples of the hydrocarbons having 2 to 20 carbon atoms include ethylene, propylene, 1-butene, 1-hexene, 1-heptene, 1-octene, 1-decene, 1-tetradecene, 1-hexadecene, 1-heptadecene, 1-octadecene, 4-methyl-1-pentene, and 1-eicosene. Preferable are ethylene, propylene, 1-butene, and 4-methyl-1-pentene. These may be used alone, or two or more thereof may be used in combination.

The weight-average molecular weight of the polyolefin is preferably 5.0×10² to 1.0×10⁷. At a weight-average molecular weight less than 5.0×10², the heat resistance of the polyolefin is remarkably reduced, and the polyolefin is easily decomposed. At a weight-average molecular weight more than 1.0×10⁷, solubility of the polyolefin in a solvent is poor, and the particle size is difficult to reduce. The weight-average molecular weight of the polyolefin can be measured by gel permeation chromatography (GPC).

Preferably, the relative permittivity at a frequency of 1 MHz of the polyolefin is 3.0 or less. This is because, at a relative permittivity more than 3.0, the effect of reducing the relative permittivity of the resin composition is difficult to obtain. Preferably, the dielectric loss tangent at a frequency of 1 MHz of the polyolefin is 0.005 or less.

The mean particle size of the polyolefin particles (B) to be added as a raw material is preferably as small as possible, and 100 μm or less, preferably 0.001 to 50 μm, and more preferably 0.01 to 20 μm. If the mean particle size of the polyolefin particles (B) is within the range, dispersibility in the heat-resistant resin (A) such as polyimides can be increased.

The polyolefin particles (B) can be obtained by a known method. Examples of the known method include a method in which polyolefin is crushed to obtain polyolefin fine particles; a method in which using a solid olefin polymerization catalyst having a controlled fine-particle shape, an olefin monomer is directly subjected to a polymerization reaction to obtain polyolefin fine particles; and a method in which an aqueous dispersion of polyolefin fine particles prepared by an emulsion method is dried to obtain polyolefin fine particles.

Examples of a method for producing an aqueous dispersion of polyolefin include a drum emulsion method in which polyolefin, water, and an emulsifier are mixed in batch to emulsify the mixture; a crushing method in which polyolefin crushed in advance and an emulsifier are put into water and dispersed; a solvent exchange method in which polyolefin dissolved in an organic solvent, an emulsifier, and water are mixed, and the organic solvent is removed; a homomixer method in which polyolefin, water, and an emulsifier are emulsified by a homomixer; and a phase inversion method.

Many of the heat-resistant resins (A) such as polyimides have polarity. Therefore, the non-polar polyolefin particles are difficult to uniformly disperse in the heat-resistant resin (A) such as polyimides. Unless the polyolefin particles (B) can be uniformly dispersed in heat-resistant resin (A), the effect of suppressing increase in the thermal expansion coefficient is not sufficiently obtained. Further, unless the polyolefin particles (B) can be uniformly dispersed in the heat-resistant resin (A), phase separation is caused, and surface smoothness of the coating film is likely to be reduced. In a substrate for a circuit using a film having low surface smoothness, the transmission loss is likely to be increased. From these, preferably, the polyolefin particles (B) are uniformly dispersed in the heat-resistant resin (A) such as polyimides. Therefore, the polyolefin particles (B) preferably have a polar group.

Examples of the polar group include a hydroxyl group, a carboxyl group, an amino group, an amide group, an imide group, an ether group, a urethane group, a urea group, a phosphate group, a sulfonate group, and a carboxylic anhydride group. Preferable are a hydroxyl group, a carboxyl group, and a carboxylic anhydride group. The polyolefin particles (B) having such a polar group have high dispersibility in the heat-resistant resin (A) such as polyimides.

The content of the polar group is preferably 1.0×10⁻⁵ to 1.0×10² mol/kg, and more preferably 1.0×10⁻³ to 1.0×10¹ mol/kg. The content of the polar group is the number of moles of the polar group (the number of moles) based on the weight (kg) of the polyolefin particle. The content of the polar group can be adjusted by adjusting an amount of a polar group-containing compound to be blended when the polyolefin particles are graft modified, or by adjusting the blending ratio of a polyolefin having no polar group to a polyolefin having a polar group or the blending ratio of a polyolefin having a large amount of the polar group to a polyolefin having a small amount of the polar group in the case where two or more polyolefins are contained.

The polyolefin having the polar group can be obtained by a method in which a polyolefin is graft modified with a polar group-containing compound, for example.

The graft modification of the polyolefin is performed, for example, by the following methods: a method in which a mixture of a polyolefin and a polar group-containing compound is reacted in a molten state (with a kneading extruder or the like) in the presence of a radical polymerization initiator or in the absence thereof; and a method in which a polyolefin and a polar group-containing compound are dissolved in a good solvent and reacted in the presence of a radical polymerization initiator.

The polar group-containing compound may be any compound having at least a carbon-carbon unsaturated bond (for example, a carbon-carbon double bond) in the molecule and a polar group. Examples of the polar group-containing compound include unsaturated carboxylic acids, unsaturated carboxylic acid derivatives, unsaturated epoxy compounds, unsaturated alcohols, unsaturated amines, and unsaturated isocyanic acid esters.

Examples of the unsaturated carboxylic acids include (meth)acrylic acids, maleic acid, fumaric acid, tetrahydrophthalate, itaconic acid, citraconic acid, crotonic acid, isocrotonic acid, norbornenedicarboxylic acid, and bicyclo[2,2,1]hept-2-ene-5,6-dicarboxylic acid. Examples of the derivatives of the unsaturated carboxylic acids include derivatives such as acid anhydrides thereof, acid halides thereof, amides thereof, imides thereof, and esters thereof. Specific examples of these include: maleyl chloride, maleimide, maleic anhydride, itaconic anhydride, citraconic anhydride, tetrahydrophthalic anhydride, and bicyclo[2,2,1]hept-2-ene-5,6-dicarboxylic anhydride;

dimethyl maleate, monomethyl maleate, diethyl maleate, diethyl fumarate, dimethyl itaconate, diethyl citraconate, dimethyl tetrahydrophthalate, and dimethyl bicyclo[2,2,1]hept-2-ene-5,6-dicarboxylate;

(meth)acrylate esters such as hydroxyethyl (meth)acrylate, 2-hydroxypropyl(meth)acrylate, 3-hydroxypropyl(meth)acrylate, 2-hydroxy-3-phenoxy-propyl (meth)acrylate, 3-chloro-2-hydroxypropyl (meth)acrylate, glycerol mono(meth)acrylate, pentaerythritol mono(meth)acrylate, trimethylolpropane mono(meth)acrylate, tetramethylolethane mono(meth)acrylate, butanediol mono(meth)acrylate, polyethylene glycol mono(meth)acrylate, and 2-(6-hydroxyhexanoyloxy)ethyl acrylate;

glycidyl(meth)acrylate; and

aminoethyl (meth)acrylate and aminopropyl (meth)acrylate. Among these, preferable are (meth)acrylic acids, maleic anhydride, hydroxyethyl (meth)acrylate, glycidyl (meth)acrylate, and aminopropyl (meth)acrylate.

Examples of the unsaturated epoxy compound include: glycidyl acrylate and glycidyl methacrylate;

monoalkyl glycidyl esters and diglycidyl esters (an alkyl group contained in monoalkyl glycidyl ester has 1 to 12 carbon atoms) of dicarboxylic acids such as maleic acid, fumaric acid, crotonic acid, tetrahydrophthalic acid, itaconic acid, citraconic acid, endo-cis-bicyclo[2.2.1]hept-5-ene-2,3-dicarboxylic acid (Nadic Acid™), endo-cis-bicyclo[2.2.1]hept-5-ene-2-methyl-2,3-dicarboxylic acid (methyl Nadic Acid™), and allyl succinic acid; and monoalkyl glycidyl esters and diglycidyl esters (an alkyl group contained in monoalkyl glycidyl ester has 1 to 12 carbon atoms) of tricarboxylic acids such as butene tricarboxylic acid; and

alkyl glycidyl esters of p-styrenecarboxylic acid, allyl glycidyl ether, 2-methylallyl glycidyl ether, styrene-p-glycidyl ether, 3,4-epoxy-1-butene, 3,4-epoxy-3-methyl-1-butene, 3,4-epoxy-1-pentene, 3,4-epoxy-3-methyl-1-pentene, 5,6-epoxy-1-hexene, and vinylcyclohexene monooxide.

Examples of the unsaturated alcohols include 10-undecen-1-ol, 1-octen-3-ol, 2-methanolnorbornene, hydroxystyrene, hydroxyethyl vinyl ether, hydroxybutyl vinyl ether, N-methylolacrylamide, 2-(meth)acryloyloxyethyl acid phosphate, glycerol monoallylether, allyl alcohol, allyloxyethanol, 2-butene-1,4-diol, and glycerol monoalcohol.

Examples of the unsaturated amines include alkyl ester derivatives of (meth)acrylic acids such as aminoethyl (meth)acrylate, propylaminoethyl (meth)acrylate, dimethylaminoethyl methacrylate, aminopropyl (meth)acrylate, phenylaminoethyl methacrylate, and cyclohexyl amino ethyl methacrylate;

vinylamine derivatives such as N-vinyldiethylamine and N-acetylvinylamine;

allylamine derivatives such as allylamine, methacrylamine, N-methylacrylamine, N,N-dimethylacrylamide, and N,N-dimethylaminopropylacrylamide;

acrylamide derivatives such as acrylamide and N-methylacrylamide;

aminostyrenes such as p-aminostyrene; and

6-aminohexylsuccinimide and 2-aminoethylsuccinimide.

Examples of the polyolefins having a polar group include olefin block copolymers having a polar group, which are obtained by a method described in Japanese Patent Application Laid-Open No. 2001-348413 and the like. The olefin block copolymer having a polar group can be produced by the steps of: 1) preparing a polyolefin having an element in Group 13 bonded to a terminal thereof; 2) subjecting a cyclic monomer to chain polymerization reaction such as ring-opening polymerization reaction in the presence of the polyolefin; and 3) when necessary, converting the terminal of the segment obtained by the chain polymerization reaction of the cyclic monomer to a polar group or introducing a polar group to the terminal.

The polyolefin having an element in Group 13 bonded to a terminal thereof in step 1) can be obtained by polymerizing an olefin monomer in the presence of an organic metal catalyst containing an element in Group 13, for example. The organic metal catalyst containing an element in Group 13 can be organic aluminum, organic boron compounds, and the like.

Examples of the cyclic monomer in step 2) include lactone, lactam, 2-oxazoline, and cyclic ether. Examples of the polar group in step 3) include the polar groups above.

The olefin block copolymer having a polar group can be represented by the following formula (3):

PO-f-R—(X)ₙ-h (3)

In the formula (3), f is a residue of a linker that links the Group 13 element to R in the polyolefin having the Group 13 element. f can be an ether bond, an ester bond, an amide bond, or the like. In the formula (3), R is a segment obtained in the chain polymerization reaction of the cyclic monomer. h represents the polar group above; (X)ₙ is a linker that links the segment R to the polar group h. X that forms the linker is not particularly limited, and includes an ester bond, an amide bond, an imide bond, a urethane bond, a urea bond, a silyl ether bond, and a carbonyl bond.

Alternatively, the polyolefin particles (B) having a polar group is obtained by subjecting polyolefin particles to surface hydrophilization treatment by a dry process. The surface hydrophilization treatment may be any surface treatment that can give a polar group, and examples thereof include a corona treatment, a plasma treatment, irradiation with an electron beam, and an UV ozone treatment.

The content of the polyolefin particles (B) in the resin composition is preferably 5 weight parts to 200 weight parts, and more preferably 10 to 100 weight parts based on 100 weight parts of the heat-resistant resin (A). This is because, when the content of the polyolefin particles (B) is less than the range, the effect of reducing the permittivity of the resin composition is difficult to obtain; and when the content of the polyolefin particles (B) is more than the range, the heat resistance of the resin composition is likely to be reduced (the thermal expansion coefficient is likely to be increased).

About Other Component

The resin composition may contain an inorganic filler and the like when necessary from the viewpoint of enhancing the heat resistance and heat dissipating properties. Examples of the inorganic filler include silica, alumina, titanium oxide, magnesium oxide, aluminum hydroxide, magnesium hydroxide, basic magnesium carbonate, dolomite, calcium sulfate, potassium titanate, barium sulfate, calcium sulfite, talc, clay, mica, glass flakes, glass beads, calcium silicate, montmorillonite, bentonite, and molybdenum sulfide. Preferable is silica. The mean particle size of the inorganic filler is preferably 0.1 to 60 μm, and more preferably 0.5 to 30 μm.

The resin composition may contain a variety of additives such as a flame retardant, a heat stabilizer, an oxidation stabilizer, and a light stabilizer, when necessary.

In the resin composition having a phase of the polyolefin particles, the flame resistance may be reduced compared to that of a resin containing no polyolefin particle. For this reason, preferably, the resin composition that forms the resin layer (1) further contains a flame retardant.

Examples of the flame retardant include organic halogen flame retardants; a combination of an organic halogen flame retardant with one or more selected from the group consisting of antimony oxide, zinc borate, zinc stannate, and iron oxide; organic phosphorus flame retardants; a combination of an organic phosphorus flame retardant with a silicone compound; a combination of inorganic phosphorus such as red phosphorus, organopolysiloxane, and an organic metal compound; hindered amine flame retardants; and inorganic flame retardants such as magnesium hydroxide, alumina, calcium borate, and low melting point glass. These may be used alone, or two or more thereof may be used in combination.

Examples of the organic halogen flame retardant include at least one compound selected from the group consisting of halogenated bisphenol compounds, halogenated epoxy compounds, and halogenated triazine compounds. Among these, preferably, the halogen atom contained in the organic halogen flame retardant is at least one of bromine and chlorine from the viewpoint of efficiently increasing the flame resistance of the resin.

Examples of such a halogenated bisphenol compound include tetrabromobisphenol A, dibromobisphenol A, tetrachlorobisphenol A, dichlorobisphenol A, tetrabromobisphenol F, dibromobisphenol F, tetra chlorobisphenol F, dichlorobisphenol F, tetrabromobisphenol S, dibromobisphenol S, tetrachlorobisphenol S, and dichlorobisphenol S.

Preferably, the organic phosphorus flame retardant is one or more selected from the group consisting of phosphate compounds, phosphine compounds, phosphinic acid salt compounds, phosphine oxide compounds, and phosphazene compounds.

Examples of the phosphate compounds include phosphoric acid esters such as trimethyl phosphate, triethyl phosphate, tributyl phosphate, trioctyl phosphate, triphenyl phosphate, tricresyl phosphate, trixylyl phosphate, cresyl diphenyl phosphate, xylyl diphenyl phosphate, tolyl dixylyl phosphate, and tris(nonylphenyl) phosphate, and (2-ethylhexyl)diphenyl phosphate;

hydroxyl group-containing phosphoric acid esters such as resorcinol diphenyl phosphate and hydroquinone diphenyl phosphate; and

condensed phosphoric acid ester compounds such as resorcinol bis(diphenyl phosphate), hydroquinone bis(diphenyl phosphate), bisphenol-A bis(diphenyl phosphate), bisphenol-S bis(diphenyl phosphate), resorcinol bis(dixylyl phosphate), hydroquinone bis(dixylyl phosphate), bisphenol-A bis(ditolyl phosphate), biphenol-A bis(dixylyl phosphate), and bisphenol-S bis(dixylyl phosphate).

Examples of the phosphine compound include trilauryl phosphine, triphenyl phosphine, and tritolyl phosphine.

The phosphinic acid salt compound is represented by the following formula (4).

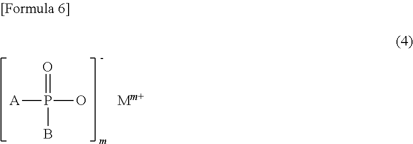

In the formula (4), A and B each independently represent a linear or branched alkyl group or aryl group having 1 to 6 carbon atoms. M represents at least one metal atom selected from the group consisting of Mg, Ca, Al, Sb, Sn, Ge, Ti, Zn, Fe, Zr, Ce, Bi, Sr, Mn, Li, Na, and K. m represents an integer of 1 to 4.

Specific examples of the phosphinic acid salt compound include diethylphosphinic acid aluminum salt, and diethylphosphinic acid magnesium salt.

Examples of the phosphine oxide compound include triphenylphosphine oxide and tritolylphosphine oxide.

Examples of the phosphazene compound include: hexaphenoxycyclotriphosphazene, monophenoxypentakis(4-cyanophenoxy)cyclotriphosphazene, diphenoxytetrakis(4-cyanophenoxy)cyclotriphosphazene, triphenoxytris(4-cyanophenoxy)cyclotriphosphazene, tetraphenoxybis(4-cyanophenoxy)cyclotriphosphazene, pentaphenoxy(4-cyanophenoxy)cyclotriphosphazene, monophenoxypentakis(4-methoxyphenoxy)cyclotriphosphazene, diphenoxytetrakis(4-methoxyphenoxy)cyclotriphosphazene, triphenoxytris(4-methoxyphenoxy)cyclotriphosphazene, tetraphenoxybis(4-methoxyphenoxy)cyclotriphosphazene, pentaphenoxy(4-methoxyphenoxy)cyclotriphosphazene, monophenoxypentakis(4-methylphenoxy)cyclotriphosphazene, diphenoxytetrakis(4-methylphenoxy)cyclotriphosphazene, triphenoxytris(4-methylphenoxy)cyclotriphosphazene, tetraphenoxybis(4-methylphenoxy)cyclotriphosphazene, pentaphenoxy(4-methylphenoxy)cyclotriphosphazene, triphenoxytris(4-ethylphenoxy)cyclotriphosphazene, triphenoxytris(4-propylphenoxy)cyclotriphosphazene, monophenoxypentakis(4-cyanophenoxy)cyclotriphosphazene, diphenoxytetrakis(4-hydroxyphenoxy)cyclotriphosphazene, triphenoxytris(4-hydroxyphenoxy)cyclotriphosphazene, tetraphenoxybis(4-hydroxyphenoxy)cyclotriphosphazene, pentaphenoxy(4-hydroxyphenoxy)cyclotriphosphazene, triphenoxytris(4-phenylphenoxy)cyclotriphosphazene, triphenoxytris(4-methacrylphenoxy)cyclotriphosphazene, and triphenoxytris(4-acrylphenoxy)cyclotriphosphazene.

Examples of the heat stabilizer and the oxidation stabilizer include Irganox and Irgafos made by Ciba Specialty Chemicals Inc. Examples of the light stabilizer include TINUVIN and CHIMASSORB made by Ciba Specialty Chemicals Inc.

As described above, in order to reduce the transmission loss of the electric signal, it is required that a resin composition suitable for use of the electric signal with a higher frequency has a low permittivity (or relative permittivity) or a low dielectric loss tangent. The relative permittivity is the ratio of a permittivity ∈ of a medium to the vacuum permittivity ∈₀. Contrary to this, the resin composition contains the polyolefin particles having a low permittivity, and therefore has a low permittivity and a low dielectric loss tangent. The relative permittivity of the resin composition at a frequency of 1 MHz is preferably 3.3 or less, and more preferably 3.0 or less.

The dielectric loss tangent at a frequency of 1 MHz of the resin composition is preferably 0.01 or less, and more preferably 0.008 or less. At a dielectric loss tangent more than 0.01, the transmission loss may be increased.

The relative permittivity and dielectric loss tangent of the resin composition may be measured by the following procedure.

1) A film (having thickness of 30 μm) comprising the resin composition is prepared. A conductive paste is applied to both surfaces of the film and dried to obtain a film with an electrode (having thickness of 20 to 30 μm).

2) In the film with an electrode obtained in 1), a capacitance (Cₚ) and conductance (G) at 25° C., humidity of 50%, and a measurement frequency of 1 MHz are measured by a capacitance method.

3) The value of the capacitance (Cₚ) and the value of the conductance (G) obtained in 2) are substituted into the following equations to calculate the relative permittivity (∈ᵣ) and the dielectric loss tangent (tan δ) at the measurement frequency of 1 MHz.

$${ɛ}_{r} = \frac{t \times {C}_{p}}{π \times {( \frac{d}{2} )}^{2} \times {ɛ}_{0}} \\ tan δ = \frac{G}{2 π {fC}_{p}} \qquad [ Expression 1 ]$$

In the equations above, Cₚ: capacitance (F), G: conductance (S), t: thickness of the polyimide film (m), π×(d/2)²: area of the electrode (m²), ∈₀: vacuum permittivity=8.854×10⁻¹² (F/m), and f: measurement frequency (Hz).

Moreover, in the present invention, the mean particle size of the polyolefin particles to be added is reduced, or the polar group is given to the polyolefin particles to be added, thereby to enhance dispersibility of the polyolefin particles (B) in the heat-resistant resin (A). For this reason, in the resin composition to be obtained, a fine polyolefin dispersed phase is uniformly dispersed.

The mean particle size of the dispersed phase obtained from the polyolefin particles (B) in the resin composition is preferably 100 μm or less, more preferably 0.001 to 50 μm, and still more preferably 0.01 to 20 μm. The mean particle size of the dispersed phase obtained from the polyolefin particles (B) can be measured by using a TEM to observe the cross section of the film comprising the resin composition containing the dispersed phase, for example.

As described above, the resin composition has a characteristic of a low thermal expansion coefficient. In spite of a high thermal expansion coefficient of the polyolefin, an increase in the thermal expansion coefficient of the resin composition is suppressed. Although the reason is not necessarily clear, it is presumed as one of the reasons that the polyolefin is dispersed well. For example, in order to suppress warpage in the substrate for a circuit attributed to the difference in the thermal expansion coefficient between the resin layer (I) and the metallic layer, for example, in the case where the metallic layer is a copper layer, the thermal expansion coefficient of the resin composition that forms the resin layer (I) is preferably 60 ppm/° C. or less, and more preferably 50 ppm/° C. or less. The thermal expansion coefficient of the resin composition is determined by measuring a thermal expansion coefficient when the resin composition is formed into a film having a thickness of 30 μm under a dry air atmosphere at a temperature in the range of 100° C. to 200° C., using a Thermomechanical Analyzer TMA50 (made by SHIMADZU Corporation).

The resin composition is obtained by the following methods: a method in which the heat-resistant resin (A) and the polyolefin particles (B) are melt kneaded; and a method in which a monomer that forms the heat-resistant resin (A) or a precursor of the heat-resistant resin (A) is mixed with the polyolefin particles (B), and the mixture is subjected to a polymerization reaction, for example.

In the case where the heat-resistant resin (A) is polyimide, the resin composition can be produced by the steps of 1) preparing polyamic acid varnish, 2) adding the polyolefin particles (B) to the polyamic acid varnish, and stirring the varnish, and 3) heating the obtained polyamic acid varnish so as to imidize the polyamic acid varnish.

The polyamic acid varnish in step 1) contains polyamic acid, and preferably a solvent. The concentration of the resin solid content in the polyamic acid varnish is preferably 1 to 40% by weight, and more preferably 10 to 30% by weight. This is for suitable control of the stirring condition described later.

The solvent is not particularly limited, and is preferably aprotic polar solvents, and more preferably aprotic amide solvents. Examples of the aprotic amide solvents include N,N-dimethylformamide, N,N-dimethylacetamide, N,N-diethylacetamide, N-methyl-2-pyrrolidone, and 1,3-dimethyl-2-imidazolidinone. These solvents may be used alone, or two or more thereof may be used in combination.

Other than these solvents, other solvent may be further contained as required. Examples of the other solvent include benzene, toluene, o-xylene, m-xylene, p-xylene, o-chlorotoluene, m-chlorotoluene, p-chlorotoluene, o-bromotoluene, m-bromotoluene, p-bromotoluene, chlorobenzene, bromobenzene, methanol, ethanol, n-propanol, isopropyl alcohol, and n-butanol.

In step 2), the polyolefin particles (B) are added to the polyamic acid varnish and stirred to disperse the polyolefin particles (B) in the polyamic acid varnish. Stirring can be ordinary conducted using a stirring blade or using a rotating and revolving mixer. The polyolefin particles (B) to be added may be particles themselves, or a dispersion prepared through dispersing the particles in a solvent.

As described above, the polyolefin particles having no polar group is difficult to disperse in the polyamic acid varnish (having a polarity). Namely, in the present invention, it is important to control the dispersion state such that the polyolefin particles (B) are uniformly dispersed in the polyamic acid varnish without aggregating the polyolefin particles (B). As described above, the dispersion state of the polyolefin particles (B) can be controlled by giving a polar group to the polyolefin particles (B) to be added, by properly selecting the mean particle size and the concentration of the polyolefin particles (B) to be added, by properly selecting the solvent in which the polyolefin particles (B) are dispersed, or by adjusting shear strength in stirring.

For example, in order to enhance dispersibility, the mean particle size of the polyolefin particles (B) to be added is preferably as small as possible. However, if the mean particle size is excessively small, the polyolefin particles (B) are likely to aggregate. Accordingly, the mean particle size is preferably 100 μm or less, more preferably 0.001 to 50 μm, and still more preferably 0.01 to 20 μm. Preferably, in order to enhance the dispersibility in the polyamic acid varnish, the solvent in which the polyolefin particles (B) to be added are dispersed is a solvent having a high compatibility with the solvent contained in the polyamic acid varnish.

The dispersion state of the polyolefin particles in the resin composition can be observed by using a TEM to observe the cross section of the film obtained from the resin composition, for example.

The viscosity of the polyamic acid varnish to which the polyolefin particles (B) are added is not particularly limited, the viscosity being measured at 25° C. and 5.0 rpm by an E-type viscometer. Preferably, the viscosity is in the range of 1 to 2.0×10⁵ mPa·s from the viewpoint of easy control of the thickness of the coating.

In step 3), the polyamic acid varnish to which the polyolefin particles (B) are added is applied to a glass substrate or the like, and heated to remove the solvent and imidize (ring close) the polyamic acid varnish. For this reason, the heating temperature is, for example, approximately 100 to 400° C., and the heating time is, for example, approximately for 3 minutes to 12 hours.

The polyamic acid is usually imidized at atmospheric pressure, or may be imidized under pressure applied. The atmosphere during imidization is not particularly limited. Usually, the atmosphere is air, nitrogen, helium, neon, argon, or the like. Preferable is nitrogen or argon that are an inactive gas.

### 2. Application of Metal-Resin Composite

The metal-resin composite according to the present invention may be a metal laminate in which the metallic layer and the layer obtained from the resin composition are laminated directly or laminated with an intermediate layer provided between the resin layer (I) and the metallic layer; or metal-resin composite according to the present invention may be a coated metal wire in which the outer peripheral surface of the metallic wire is coated with the layer obtained from the resin composition directly or with an intermediate layer provided between the resin layer (I) and the metallic wire.

The thickness of the metallic layer in the metal laminate is preferably 2 μm or more and 150 μm or less, and more preferably 3 μm or more and 50 μM or less. The thermal expansion coefficient of copper is approximately 17 ppm/K. The thickness of an insulating layer comprising the resin composition in the metal laminate is preferably 0.1 μm or more and 100 μm or less, and more preferably 0.5 μm or more and 50 μm or less.

As described above, the metal laminate according to the present invention has an insulating layer obtained from the resin composition having a low permittivity and a high heat resistance. For this reason, the metal laminate according to the present invention is preferably used as a variety of substrates for a circuit, and particularly as a substrate for a high frequency circuit.

Such a substrate for a circuit can be obtained by the following methods, for example: 1) a method of thermally compression bonding the sheet obtained from the resin composition to a metallic foil; 2) a method of forming a conductive layer on the sheet obtained from the resin composition by sputtering, deposition, or the like; and 3) a method of applying the varnish of the resin composition onto a metallic foil and curing the varnish.

In 1), the sheet obtained from the resin composition is obtained by applying a varnish onto a support material, drying and heating the varnish, and separating the dried varnish from the support material. A method for applying a varnish is not particularly limited, and examples thereof include a spin coater, a spray coater, or a bar coater. Preferably, the thickness of the sheet obtained from the resin composition is approximately 0.1 to 200 μm because the sheet is used for a substrate for a circuit. The thermal compression-bonding temperature is not less than the glass transition temperature of the resin composition, and specifically 130 to 300° C., although the temperature depends on a combination of the resin composition and the metallic foil.

The substrate for a circuit according to the present invention has an insulating layer having a high heat resistance and a low permittivity. Accordingly, the substrate for a circuit according to the present invention can be widely used for electronic parts having a high frequency circuit, for example, various applications using a high frequency such as built-in antennas for mobile phones, antennas for radars mounted on automobiles, and home high speed wireless communication.

The thickness of the insulating layer (the layer comprising the resin composition) in the coated metal body can be approximately 0.05 to 5 mm, although the thickness depends on the diameter of the metallic wire or the insulation required.

In the coated metal body according to the present invention, the metallic wire is coated with an insulating layer comprising the resin composition having a low permittivity and a high heat resistance. For this reason, the coated metal body according to the present invention is preferably used as electric wires for a variety of cables and cords, for example.

Such an electric wire can be obtained, for example, by a method of extruding and applying (extrusion molding) the resin composition onto the outer peripheral surface of the metallic wire, or a method of injection molding the resin composition onto the outer peripheral surface of the metallic wire.

Moreover, the resin composition that forms the resin layer (I) in the metal-resin composite has a low relative permittivity and a high heat resistance. For this reason, the resin composition can be preferably used as an insulating material having a low permittivity (such as an insulating material, insulating layer, or insulating coating material having a low permittivity).

### EXAMPLES

Hereinafter, the present invention will be described more in detail with reference to Examples. The scope of the present invention should not be interpreted to be limited by these Examples. Contents of abbreviations used in the present Examples and Comparative Examples will be shown.

### (1) Solvents

DMAc: N,N-dimethylacetamide

NMP: N-methyl-2-pyrrolidone

### (2) Constituent Components of Polyimide Resin (A)

### Diamines

PDA: p-phenylenediamine

ODA: 4,4′-diaminodiphenyl ether

APB: 1,3-bis(3-aminophenoxy)benzene

DABP: 3,3′-diaminobenzophenone

m-BP: 4,4′-bis(3-aminophenoxy)biphenyl

### Acid Dianhydrides

BPDA: 3,3′,4,4′-biphenyltetracarboxylic dianhydride

PMDA: pyromellitic dianhydride

BTDA: 3,3′,4,4′-benzophenonetetracarboxylic dianhydride

### (3) Polyolefin Particles (B)

PO1: polyethylene particles (the mean particle size of 6 μm, the kind of the polar group: a group derived from maleic acid, the content of the polar group: 0.03 mol/kg)

PO2: ethylene-butene copolymer particles (the mean particle size of 4 μm, the kind of the polar group: a group derived from maleic acid, the content of the polar group: 0.03 mol/kg)

PO3: polyethylene particles (the mean particle size of 10 μm, no polar group)

### Example 1

### Preparation of Polyamic Acid A

20.55 g of PDA and 301 g of NMP as a solvent were placed in a container provided with a stirrer and a nitrogen introducing pipe. The temperature of the solution was raised to 50° C., and the solution was stirred until PDA was dissolved. The temperature of the solution was cooled to room temperature. Then, 55.34 g of BPDA was supplied over approximately 30 minutes, and 129 g of NMP was further added. The solution was stirred for 20 hours to obtain a varnish of Polyamic Acid A. In the obtained varnish, the content of the solid content in Polyamic Acid A was 15% by weight, and the logarithmic viscosity was 1.3 dl/g.

### Preparation of Polyamic Acid A/PO1 Mixed Solution

50 g of the varnish of Polyamic Acid A and 12 g of a PO1/DMAc dispersion having a concentration of the solid content of 25% by weight were placed in a plastic container and mixed using a kneader to prepare a Polyamic Acid A/PO1 mixed solution.

### Production of Polyimide A/PO1 composite film

The obtained Polyamic Acid A/PO1 mixed solution was applied onto a glass plate with a baker applicator such that a dried film had a thickness of approximately 30 μm. Then, the applied solution was dried by an inert oven under a nitrogen atmosphere at 300° C. for 120 minutes. The glass plate having a coating film thus formed thereon was dipped in water at a temperature of approximately 40° C. to separate the coating film from the glass plate. Thereby, a Polyimide A/PO1 composite film having a thickness of 30 μm was obtained.

### Examples 2 and 3

A Polyimide A/PO1 composite film was obtained in the same manner as in Example 1 except that the amount of the polyethylene particles PO1 to be added was changed as shown in Table 1.

### Example 4

A Polyimide A/PO2 composite film was obtained in the same manner as in Example 1 except that the PO1/DMAe dispersion in Example 1 was replaced by a PO2/DMAc dispersion.

### Example 5

### Production of Polyamic Acid A/PO2/Flame Retardant Composite Film

50 g of the varnish of Polyamic Acid A, 9 g of a PO2/DMAc dispersion having a concentration of the solid content of 25% by weight, and 1.5 g of triphenoxytris(4-cyanophenoxy)cyclotriphosphazene (made by FUSHIMI Pharmaceutical Co., Ltd., Rabitle FP-300) as a flame retardant were placed in a plastic container and mixed using a kneader. Thereby, a Polyamic Acid A/PO2/flame retardant mixed solution was prepared. Using the mixed solution, a Polyimide A/PO2/flame retardant composite film was obtained in the same manner as in Example 1.

### Example 6

### Preparation of Polyamic Acid B

24.03 g of ODA and 139.5 g of DMAc as a solvent were placed in a container provided with a stirrer and a nitrogen introducing pipe and stirred until ODA was dissolved. Next, 25.78 g of PMDA was supplied to the solution over approximately 30 minutes, and 103.7 g of DMAc was further added. The solution was stirred for 20 hours to obtain a varnish of Polyamic Acid B. In the obtained varnish, the content of the solid content in Polyamic Acid B was 17% by weight, and the logarithmic viscosity was 1.2 dl/g.

A Polyamic Acid B/PO1 mixed solution was prepared in the same manner as in Example 1 except that the PO1/DMAc dispersion was mixed with the obtained varnish of Polyamic Acid B such that the amount ratio of Polyamic Acid B/PO1 was as shown in Table 2. Then, a Polyimide B/PO1 composite film was obtained by the same method as that in Example 1.

### Example 7

A Polyamic Acid B/PO3 mixed solution was prepared in the same manner as in Example 1 except that a PO3/DMAc dispersion was mixed with the obtained varnish of Polyamic Acid B such that the amount ratio of Polyamic Acid B/PO3 was as shown in Table 2. Then, a Polyimide B/PO3 composite film was obtained by the same method as that in Example 1.

### Example 8

### Preparation of Polyamic Acid C

261.0 g of DMAc as a solvent was added to a container provided with a stirrer and a nitrogen introducing pipe, and 20.44 g of ODA and 16.12 g of m-BP were further added to the solvent. The solution was stirred at 20 to 30° C., and ODA and m-BP were dissolved. Next, 30.84 g of PMDA was added, and the raw material adhering to the inside of a flask was washed off with 11.0 g of DMAc. The solution was heated to 50 to 60° C., and stirred for approximately 1 hour. Subsequently, 0.44 g of PMDA was further added. The solution was stirred for approximately 4 hours while the temperature was kept at 60° C. Thus, a varnish of Polyamic Acid C1 was obtained.

On the other hand, 263.0 g of NMP as a solvent was added to another container provided with a stirrer and a nitrogen introducing pipe, and 19.62 g of PDA was added. The solution was stirred at 20 to 30° C., and PDA was dissolved. Subsequently, 37.0 g of BPDA and 11.06 g of PMDA were further added, and the raw material adhering to the inside of a flask was washed off with 10.0 g of NMP. The solution was heated to 50 to 60° C., and was stirred for approximately 4 hours to obtain a varnish of Polyamic Acid C2.

Moreover, in another container provided with a stirrer and a nitrogen introducing pipe, the varnish of Polyamic Acid C2 and the varnish of Polyamic Acid C1 were mixed in the weight ratio of (C2):(C1)=77:23, heated to 50 to 60° C. and stirred for approximately 4 hours to obtain a varnish of Polyamic Acid C. In the obtained varnish of Polyamic Acid C, the content of Polyamic Acid C was 20% by weight, and the E-type viscosity at 25° C. was 30000 mPa·s.

### Preparation of Polyamic Acid C/PO2/Flame Retardant Composite Film

36.2 g of the varnish of Polyamic Acid C, 2 g of ethylene-butene copolymer particles PO2, and 0.75 g of phosphinic acid aluminum salt as a flame retardant (made by Clariant (Japan) K.K., Exolit OP935) were placed in a plastic container and mixed using a kneader to prepare a Polyamic Acid C/PO2/flame retardant mixed solution. Using the mixed solution, a Polyimide C/PO2/flame retardant composite film was obtained in the same manner as in Example 1.

### Comparative Example 1

A polyimide film was obtained in the same manner as in Example 1 except that the polyethylene particles PO1 were not added.

### Comparative Example 2

A polyimide film was obtained in the same manner as in Example 6 except that the polyethylene particles PO1 were not added.

### Comparative Example 3

A polyimide film was obtained in the same manner as in Example 8 except that the polyethylene particles PO2 and the flame retardant were not added.

### Example 9

### Preparation of Polyamic Acid D

In a container provided with a stirrer, a reflux cooler, and a nitrogen introducing pipe, 212 g of DABP was dissolved in 1230 g of DMAc. Under a nitrogen atmosphere, 316 g of BTDA was added to the solution, and stirred at 10° C. for 24 hours to obtain a varnish of Polyimidic Acid D. The varnish of Polyamic Acid D was diluted with DMAc to 15.0% by weight, and the viscosity was adjusted to 200 mPa·s at 25° C.

### Preparation of Polyamic Acid E

292 g of APB and 321 g of BTDA were weighed and added to 3743 g of DMAc. The solution was stirred at 23° C. for 4 hours to obtain a varnish of Polyamic Acid E. The concentration of the solid content in the varnish of Polyamic Acid E was 15% by weight. The viscosity of the varnish of Polyamic Acid E was 500 mPa·s.

Production of Double-Sided Metal Laminate

As a metallic foil, an electrodeposited copper foil having a thickness of 12 μm was prepared. The varnish of Polyamic Acid D was uniformly applied onto the surface of the electrodeposited copper foil by casting with a roll coater such that the thickness of the varnish after imidization was approximately 1 μm, and dried at 100° C. for 4 minutes. Thereby, a first layer of a Polyamic Acid D layer was formed.

The Polyamic Acid C/PO2/flame retardant mixed solution prepared in Example 8 was uniformly applied onto the surface of the obtained Polyamic Acid D layer by casting with a die coater such that the thickness of the varnish after imidization was approximately 10 μm, and dried at 130° C. for 4 minutes. Thereby, a second layer of a Polyamic Acid C′ layer was formed.

The varnish of Polyamic Acid E was uniformly applied onto the surface of the obtained Polyamic Acid C′ layer by casting with a roll coater such that the thickness of the varnish after imidization was approximately 2 μm, and dried at 100° C. for 4 minutes. Thereby, a third layer of a Polyamic Acid E layer was formed.

Next, the respective polyamic acid layers on the copper foil were dried at 200° C. for 4 minutes, and further heated in a nitrogen atmosphere at 380° C. (the concentration of oxygen of 0.5 vol % or less) for 3 minutes to be imidized. Thus, a single-sided metal laminate having the three polyimide layers was obtained. The other single-sided metal laminate was produced in the same manner.

The polyimide layers in the obtained two single-sided metal laminates were attached together, and heat pressed with a press machine under the condition of a press pressure of 2 MPa and a temperature of 320° C. for 4 hours to obtain a double-sided metal laminate. Subsequently, the electrodeposited copper foils of the double-sided metal laminate were removed by etching. Using the obtained resin laminate film, various measurements were performed.

### Comparative Example 4

A double-sided metal laminate was obtained in the same manner as in Example 9 except that instead of the second layer of the Polyamic Acid C′ layer, a Polyamic Acid C layer obtained by applying the varnish of Polyamic Acid C was used. Subsequently, the electrodeposited copper foils of the double-sided metal laminate were removed by etching. Using the obtained resin laminate film, various measurements were performed.

In the polyimide/polyolefin composite films obtained in Examples 1 to 8, the polyimide films obtained in Comparative Examples 1 to 3, and the resin laminate films being the metal laminates obtained in Example 9 and Comparative Example 4, the thermal expansion coefficient, the heat distortion temperature, the dielectric properties (the relative permittivity and the dielectric loss tangent), the tensile strength, the tensile modulus of elasticity, the surface roughness, and the flame resistance were measured as follows. Moreover, the dispersion state of the dispersed phase obtained from the polyethylene particles in the polyimide/polyolefin composite film obtained in Example 1 was observed as follows.

(1) Thermal Expansion Coefficient

Using a Thermomechanical Analyzer TMA50 series (made by SHIMADZU Corporation), the thermal expansion coefficient of the obtained film was measured under a dry air atmosphere at a temperate in the range of 100° C. to 200° C.

(2) Heat Distortion Temperature

Using a Thermomechanical Analyzer (TMA-50, made by SHIMADZU Corporation), a constant load (14 g per 1 mm² of the cross section of the film) was applied to both ends of the film (the thickness of approximately 30 μm, the length of 20 mm), and the heat distortion temperature was determined by a tensile method in which expansion (shrinkage) of the film was measured when the temperature was changed from 30 to 450° C. The temperature at which the expansion of the film was significantly increased was defined as the heat distortion temperature.

(3) Relative Permittivity, Dielectric Loss Tangent

A conductive paste was applied onto both surfaces of the obtained film to form an electrode having a thickness of 20 to 30 μm. The material of the conductive paste was silver. Using a HP4294A Precision Impedance Analyzer made by Yokogawa Hewlett-Packard Ltd., a current was flowed through the electrode formed on the film, and the capacitance (Cₚ) and conductance (G) of the polyimide film were measured under an environment of a temperature of 23° C. and a humidity of 50%. The obtained values were substituted into the following equations to calculate the relative permittivity (∈ᵣ) and dielectric loss tangent (tan δ) at a measurement frequency of 1 MHz.

$${ɛ}_{r} = \frac{t \times {C}_{p}}{π \times {( \frac{d}{2} )}^{2} \times {ɛ}_{0}} \\ tan δ = \frac{G}{2 π {fC}_{p}} \qquad [ Expression 2 ]$$

Cₚ: capacitance (F), G: conductance (S), t: thickness (m) of the polyimide film, π×(d/2)²: area of the electrode (m²), ∈₀: vacuum permittivity=8.854×10⁻¹² (F/m), f: measurement frequency (Hz)

(4) Tensile Strength, Tensile Modulus of Elasticity

The tensile strength and tensile modulus of elasticity at 23° C. of the obtained film were measured using a Table-Top Universal Testing Machine EZ Test made by SHIMADZU Corporation.

(5) Surface Roughness Test

Using a stylus surface profiler (trade name “DEKTAK3,” made by ULVAC, Inc.), the ten-point average roughness (Rz) of the film was measured.

(6) Evaluation of Flame Resistance

The obtained film was subjected to a UL94VTM burning test according to ASTM D4804, and flame resistance grades specified in the test were obtained. The film that did not satisfy the criterion for determining the flame resistance grade (the film whose flame resistance was not found) was determined as “bad.” The flame resistance has three grades of VTM-0, VTM-1 and VTM-2, showing that the flame resistance is the highest in VTM-0 and the lowest in VTM-2.

(7) Dispersion State of Polyethylene Particles PO1 in Polyimide/Polyolefin Composite Film

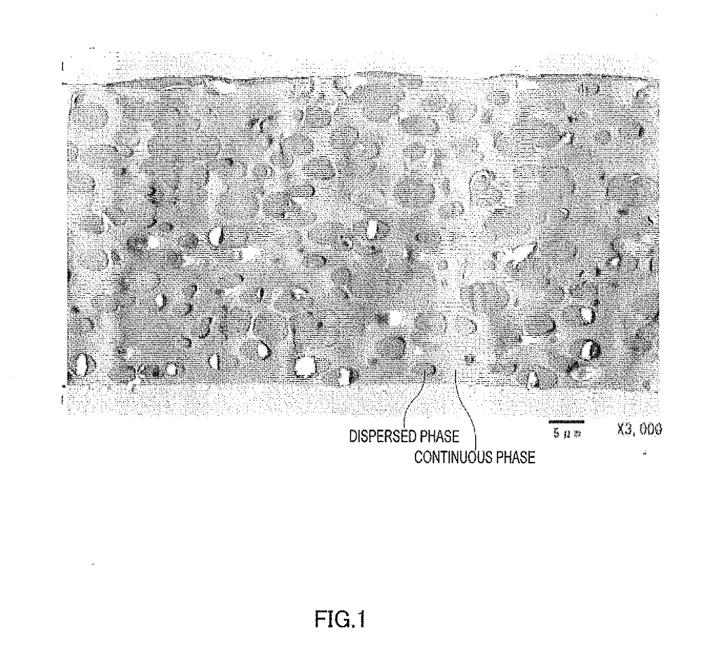

For the polyimide/polyolefin composite film in Example 1, the dispersion state of polyethylene particles PO1 was observed by a TEM. Specifically, the cross section obtained by cutting the polyimide/polyolefin composite film was observed by a transmission electron microscope (TEM) at a magnification of 3000 times to obtain a cross section TEM image. The cross section TEM image of the polyimide/polyolefin composite film in Example 1 is shown in FIG. 1.

The results obtained in Examples 1 to 5 and Comparative Example 1 are shown in Table 1; the results obtained in Examples 6 and 7 and Comparative Example 2 are shown in Table 2; the results obtained in Example 8 and Comparative Example 3 are shown in Table 3; and the results obtained in Example 9 and Comparative Example 4 are shown in Table 4.

TABLE 1

| | Heat-resistant | | | | | Flame | | |
|---|---|---|---|---|---|---|---|---|
| | resin (A) | | Polyolefin particles (B) | | | retardant | | |
| | | Amount to | | | Amount to | Amount to | Thermal | Heat |
| | | be added | | Particle | be added | be added | expansion | distortion |
| | | (parts by | | size | (parts by | (parts by | coefficient | temperature |
| | Kind | weight) | Kind | (μm) | weight) | weight) | (ppm/K) | (° C.) |
| Example 1 | Polyamic | 100 | PO1 | 6 | 40 | 0 | 5 | 312 |
| | Acid A | | | | | | | |
| Example 2 | Polyamic | 100 | PO1 | 6 | 60 | 0 | 4 | 303 |
| | Acid A | | | | | | | |
| Example 3 | Polyamic | 100 | PO1 | 6 | 80 | 0 | 9 | 304 |
| | Acid A | | | | | | | |
| Example 4 | Polyamic | 100 | PO2 | 4 | 40 | 0 | 6 | 321 |
| | Acid A | | | | | | | |
| Example 5 | Polyamic | 100 | PO2 | 4 | 30 | 20 | 5 | 310 |
| | Acid A | | | | | | | |
| Comparative | Polyamic | 100 | — | — | — | 0 | 6 | 305 |
| Example 1 | Acid A | | | | | | | |

| | | | | | Surface | |
|---|---|---|---|---|---|---|
| | | Dielectric | Tensile | Modulus of | roughness | |
| | Relative | loss | strength | elasticity | Rz | Flame |
| | permittivity | tangent | (MPa) | (GPa) | (μm) | resistance |
| Example 1 | 2.7 | 0.0042 | 168 | 5.2 | — | — |
| Example 2 | 2.6 | 0.0036 | 115 | 3.6 | — | — |
| Example 3 | 2.7 | 0.0033 | 102 | 3 | — | — |
| Example 4 | 2.4 | 0.0036 | 195 | 5.2 | — | Bad |
| Example 5 | 2.7 | 0.004 | 204 | 5.5 | — | VTM-0 |
| Comparative | 3.4 | 0.0057 | 370 | 9.3 | — | VTM-0 |
| Example 1 | | | | | | |

TABLE 2

| | Heat-resistant | | | | | Flame | | |
|---|---|---|---|---|---|---|---|---|
| | resin (A) | | Polyolefin particles (B) | | | retardant | | |
| | | Amount to | | | Amount to | Amount to | Thermal | Heat |
| | | be added | | Particle | be added | be added | expansion | distortion |
| | | (parts by | | size | (parts by | (parts by | coefficient | temperature |
| | Kind | weight) | Kind | (μm) | weight) | weight) | (ppm/K) | (° C.) |
| Example 6 | Polyamic | 100 | PO1 | 6 | 40 | 0 | 28 | 393 |
| | Acid B | | | | | | | |
| Example 7 | Polyamic | 100 | PO3 | 10 | 40 | 0 | 35 | 388 |
| | Acid B | | | | | | | |
| Comparative | Polyamic | 100 | — | — | — | 0 | 30 | 379 |
| Example 2 | Acid B | | | | | | | |

| | | | | | Surface | |
|---|---|---|---|---|---|---|
| | | Dielectric | Tensile | Modulus of | roughness | |
| | Relative | loss | strength | elasticity | Rz | Flame |
| | permittivity | tangent | (MPa) | (GPa) | (μm) | resistance |
| Example 6 | 2.5 | 0.008 | 73 | 1.3 | 1.0 | — |
| Example 7 | 3 | 0.008 | 95 | 1.1 | 3.5 | — |
| Comparative | 3.5 | 0.012 | 183 | 2.6 | <0.1 | VTM-0 |
| Example 2 | | | | | | |

TABLE 3

| | Heat-resistant | | | | | Flame | | |
|---|---|---|---|---|---|---|---|---|
| | resin (A) | | Polyolefin particles (B) | | | retardant | | |
| | | Amount to | | | Amount to | Amount to | Thermal | Heat |
| | | be added | | Particle | be added | be added | expansion | distortion |
| | | (parts by | | size | (parts by | (parts by | coefficient | temperature |
| | Kind | weight) | Kind | (μm) | weight) | weight) | (ppm/K) | (° C.) |
| Example 8 | Polyamic | 100 | PO2 | 4 | 28 | 10 | 7 | 314 |
| | Acid C | | | | | | | |
| Comparative | Polyamic | 100 | — | — | — | 0 | 7 | 315 |
| Example 3 | Acid C | | | | | | | |

| | | | | | Surface | |
|---|---|---|---|---|---|---|
| | | Dielectric | Tensile | Modulus of | roughness | |
| | Relative | loss | strength | elasticity | Rz | Flame |
| | permittivity | tangent | (MPa) | (GPa) | (μm) | resistance |
| Example 8 | 2.7 | 0.006 | 150 | 4.0 | — | — |
| Comparative | 3.4 | 0.0085 | 340 | 7.4 | — | VTM-0 |
| Example 3 | | | | | | |

TABLE 4

| | | | | Thermal | Heat | | | | Modulus | Surface | |
|---|---|---|---|---|---|---|---|---|---|---|---|
| | Layer configuration of film | | | expansion | distortion | | Dielectric | Tensile | of | roughness | |
| | | | Third | coefficient | temperature | Relative | loss | strength | elasticity | Rz | Flame |
| | First layer | Second layer | layer | (ppm/K) | (° C.) | permittivity | tangent | (MPa) | (GPa) | (μm) | resistance |
| Example 9 | Polyimide | Polyimide | Polyimide | 15 | 328 | 2.6 | 0.0047 | 143 | 4.3 | — | VTM-0 |
| | D | C′(Polyimide | E | | | | | | | | |
| | | C/PO2/flame | | | | | | | | | |
| | | retardant) | | | | | | | | | |
| Comparative | Polyimide | Polyimide C | Polyimide | 16 | 331 | 3.0 | 0.0055 | 296 | 7.4 | — | VTM-0 |
| Example 4 | D | | E | | | | | | | | |

It is found that in the polyimide/polyolefin composite films in Examples 1 to 8 in which the polyolefin particles are blended, the relative permittivity and the dielectric loss tangent are lower than those in the polyimide films in Comparative Examples 1 to 3 in which no polyolefin particles are blended. Moreover, depending on the amount of the polyolefin particles to be blended, it is found that the polyimide/polyolefin composite films in Examples 1 to 8 in which the polyolefin particles are blended have a low thermal expansion coefficient substantially equal to that of the polyimide films in the corresponding Comparative Examples 1 to 3 in which no polyolefin particles are blended.

Similarly, it is found that in the resin laminate film in the metal laminate in Example 9 in which the polyolefin particles are blended, the relative permittivity and the dielectric loss tangent are lower than those in the resin laminate film in the metal laminate in Comparative Example 4 in which no polyolefin particles are blended. Moreover, it is found that the resin laminate film in the metal laminate in Example 9 has a low thermal expansion coefficient substantially equal to that in the resin laminate film in the metal laminate in the corresponding Comparative Example 4 in which no polyolefin particles are blended.

Particularly, it is found that while the thermal expansion coefficient of polyethylene alone is usually approximately 100 to 200 ppm/K and extremely high, increase in the thermal expansion coefficient is smaller than expected even if a relatively large amount of the polyethylene particles are blended.

Particularly, comparing Example 6 with Example 7, it is found that the thermal expansion coefficient of the film in Example 6 using the polyethylene particles having a polar group is lower than that of the film in Example 7 using the polyethylene particles having no polar group. It is thought that this is because the film in Example 6 has higher dispersibility of the phase obtained from polyethylene than that of the film in Example 7.

Moreover, it is found that the ten-point average roughness (Rz) on the surface of the film in Example 6 including the polyethylene particles having a polar group is lower than that of the film in Example 7 including the polyethylene particles having no polar group. It is thought that this is because the film in Example 6 has a higher dispersibility of the phase obtained from polyethylene than that of the film in Example 7, and deterioration of the surface smoothness caused by a phase separation behavior is suppressed.

Further, Examples 4 and 5 will be compared with Comparative Example 1. It is found that the film in Example 4 containing the polyethylene particles has lower flame resistance than that of the film in Comparative Example 1 containing no polyethylene particles. It is found, however, that of the film in Example 5 containing the polyethylene particles and the flame retardant, the flame resistance in the evaluation of the flame resistance (UL94VTM burning test) is higher (VTM-0) than that of the film in Example 4 containing the polyethylene particles and containing no flame retardant.

Moreover, it is recognized that in the polyimide/polyolefin composite film in Example 1, the dispersed phase of polyolefin having the mean particle size of 0.3 to 10 μm is dispersed in the continuous phase of the polyimide resin (A), as shown in FIG. 1. Thereby, it is found that the dispersed phase of polyolefin is uniformly and well dispersed in the continuous phase of the polyimide resin. It is presumed that the white area shown in FIG. 1 is a gap. Although it is not always clear how these gaps are formed, it is presumed that these gaps are formed when the film is cut by a knife in production of a thin piece sample for the observation with the TEM, or formed by part of the polyolefin particles decomposed by some heat. From these, it is thought that a certain amount of the gaps in the film does not have a great influence on the mechanical strength of the film, and the dielectric properties can be improved.

This application claims the priority the of Japanese Patent Application No. 2010-016989, filed on Jan. 28, 2010, the disclosure of which including the specification, drawings and abstract is incorporated herein by reference in its entirety.

### INDUSTRIAL APPLICABILITY

According to the present invention, a heat-resistant resin composition having a low permittivity or dielectric loss tangent and having a low thermal expansion coefficient can be provided. For this reason, the metal-resin composite having the layer comprising the resin composition (resin layer (I)) is preferably used for a variety of substrates for a circuit (particularly, substrates for a high frequency circuit) and a variety of electric wires. Further, the substrate for a circuit according to the present invention can be widely used in various applications using a high frequency such as built-in antennas for mobile phones, antennas for radars mounted on automobiles, and home high speed wireless communication.

1. A metal-resin composite comprising a metal and a resin layer (I) provided in direct contact with the metal or provided over the metal, with an intermediate layer provided between the resin layer (I) and the metal, wherein
the resin layer (I) is obtained from a resin composition prepared by blending a heat-resistant resin (A) with polyolefin particles (B), the heat-resistant resin (A) having a relative permittivity at a frequency of 1 MHz of 2.3 or more and the polyolefin particles (B) having a mean particle size of 100 μm or less;
the resin composition has a continuous phase of the heat-resistant resin (A) and a dispersed phase obtained from the polyolefin particles (B); and
a relative permittivity of the resin composition is lower than a relative permittivity of the heat-resistant resin (A).

2. The metal-resin composite according to claim 1, wherein the heat-resistant resin (A) is at least one selected from the group consisting of polyimides, polyamideimides, liquid crystal polymers, and polyphenylene ethers.

3. The metal-resin composite according to claim 1, wherein the heat-resistant resin (A) is a polyimide.

4. The metal-resin composite according to claim 1, wherein the resin composition has a relative permittivity at a frequency of 1 MHz of 3.3 or less.

5. The metal-resin composite according to claim 1, wherein the polyolefin particles (B) are a polymer comprising a structural unit derived from at least one monomer selected from the group consisting of ethylene, propylene, 1-butene, and 4-methyl-1-pentene.

6. The metal-resin composite according to claim 1, wherein the polyolefin particles (B) have a polar group.

7. The metal-resin composite according to claim 6, wherein the polar group is at least one functional group selected from the group consisting of a hydroxyl group, a carboxyl group, an amino group, an amide group, an imide group, an ether group, a urethane group, a urea group, a phosphate group, a sulfonate group, and a carboxylic anhydride group.

8. The metal-resin composite according to claim 1, wherein the polyolefin particles (B) are subjected to a corona treatment, a plasma treatment, irradiation with an electron beam, or an UV ozone treatment.

9. The metal-resin composite according to claim 1, wherein the resin composition contains 5 weight parts or more and 200 weight parts or less of the polyolefin particles (B) based on 100 weight parts of the heat-resistant resin (A).

10. The metal-resin composite according to claim 1, wherein the resin composition further contains a flame retardant.

11. The metal-resin composite according to claim 1, wherein a dielectric loss tangent at a frequency of 1 MHz of the heat-resistant resin (A) is 0.001 or more, and a dielectric loss tangent of the resin composition is lower than the dielectric loss tangent of the heat-resistant resin (A).

12. The metal-resin composite according to claim 1, wherein
the metal is a metallic layer, and
the metal-resin composite is a metal laminate comprising the metallic layer and the resin layer (I) laminated directly or laminated with an intermediate layer provided between the resin layer (I) and the metallic layer.

13. The metal-resin composite according to claim 12, wherein the metal laminate is a substrate for a circuit.

14. The metal-resin composite according to claim 12, wherein the metal laminate is a substrate for a high frequency circuit.

15. The metal-resin composite according to claim 1, wherein
the metal is a metallic wire, and
the metal-resin composite is a coated metal body in which an outer peripheral surface of the metallic wire is coated with the resin layer (I) directly or coated with the resin layer (I), with an intermediate layer provided between the resin layer (I) and the metallic wire.

16. The metal-resin composite according to claim 15, wherein the coated metal body is an electric wire.
